(19) United States
(12) Patent Application Publication
(10) Pub. No.: US 2005/0261889 A1
(43) Pub. Date: Nov. 24, 2005

(54) Method and apparatus for extracting information, and computer product

(75) Inventor: Tomoya Iwakura, Kawasaki (JP)

Correspondence Address: Patrick G. Burns, Esq.;GREER, BURNS & CRAIN, LTD, Suite 2500, 300 South Wacker Dr., Chicago, IL, 60606, US

(73) Assignee: FUJITSU LIMITED

(21) Appl. No.: 10/963,372

(22) Filed: Oct. 12, 2004

(30) Foreign Application Priority Data
May 20, 2004 (JP) 2004-150879

(51) Int. Cl. G06F 17/28

(52) U.S. Cl. 704/4

(57) ABSTRACT

A generation-target selecting unit selects supervised data from a supervised-data storage unit. A supervised generation unit generates the supervised data to produce new supervised data. A validity determining unit makes a rule learning unit learn the generated data and the supervised data, and makes an extracting unit to extract information using test data to evaluate a result of extracting the information. When the result is improved compared with a result before adding the supervised data generated, the supervised data generated is taken as the correct supervised data.

### BACKGROUND OF THE INVENTION

1) Field of the Invention

The present invention relates to a technology for extracting information from a text, based on an information extracting rule obtained by machine learning using supervised data.

2) Description of the Related Art

In an information extracting apparatus (an information extracting program) that extracts specific information from a text using an information extracting rule, one of the approaches for preparing an information extracting rule is a machine learning (see, for example, “Japanese Named Entity Extraction with Redundant Morphological Analysis” [Retrieved on May 12, 2004] Internet <URL: http://chasen.naist.jp/˜masayu-a/article/asahara-naacl-2003.pdf>).

Since increase in the number of versions of the supervised data leads more excellent results in the machine learning, it is important to prepare as many versions of the supervised data as possible to improve a precision of the information extracting. Examples of the machine learning include decision tree, support vector machines (SVM), and Boosting.

The decision tree expresses a rule that leads an answer from a feature (class to which an answer having the feature belongs or a probability that the feature belongs to a specific class) with a tree, based on a given feature (a condition). The tree is, for example, called “a binary tree” or “a search tree”, and it utilizes such a constitution that a route to be selected is decided for each node from a root and a answer is obtained when a leaf is reached (see, for example, “C4.5: Programs for Machine Learning”, J. Ross Quinlan, Morgan Kaufmann Pub., Dec. 1, 1993).

The SVM is a learning machine that classifies training data into positive examples and negative examples and obtains a hyper plane such that a margin between the positive examples and the negative examples are maximized. The hyper plane utilizes the fact that an optimum solution is obtained under such a concept that a structural risk is minimized (see, for example, “An Introduction to Support Vector Machines: And other Kernel-Based Learning Method”, Nello Cristianini and John Shawe-Taylor, Mar. 23, 2000).

The Boosting is an approach for constructing a sequential weak learning machines and constructing a final classifying machine by a majority rule with weight. The weak learning machine uses the decision tree or the like (see, for example, “Boostexter: A boosting-based system for text categorization”, R. E. Scapire and Y. Singer, Machine Learning, 39(2/3): 135-168, May/June 2000 (URL: http://www.boosting.org/papers/SchSin00c.pdf)).

However, an increase of the number of variations of the supervised data for improving information extracting precision is generally accompanied by an increase of cost. Only simple increase in the number of variations of supervised data causes a problem that improvement in information extracting precision can not be achieved, if the supervised data includes improper supervised data.

### SUMMARY OF THE INVENTION

It is an object of the present invention to solve at least the above problems in the conventional technology.

A computer program for extracting information from a text, based on an information extracting rule obtained by machine learning using supervised data, according to one aspect of the present invention, includes generating the supervised data to produce supervised data, and learning the information extracting rule using the supervised data.

A computer-readable recording medium according to another aspect of the present invention stores the computer program for extracting information from a text, based on an information extracting rule obtained by machine learning using generated supervised data, according to the above aspect.

An apparatus for extracting information from a text, based on an information extracting rule obtained by machine learning using generated supervised data, according to still another aspect of the present invention, includes a generating unit that generates the supervised data to produce new generated data, and a learning unit that learns the information extracting rule using the generated data.

A method of extracting information from a text, based on an information extracting rule obtained by machine learning using supervised data, according to still another aspect of the present invention, includes generating the supervised data to produce new supervised data, and inducing the information extracting rule using the generated supervised data.

A method of creating an information extracting rule that is used to extract information from a text, by machine learning using supervised data, according to still another aspect of the present invention, includes generating the supervised data to produce generated data, and creating the information extracting rule using the generated data.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a constitution of an information extracting apparatus according to an embodiment of the present invention;

FIG. 2 is a diagram of an example of a supervised data stored in a supervised data storage unit;

FIG. 3 is a diagram of another example of the supervised data stored in the supervised data storage unit;

FIG. 4 is a diagram of an example of an information extracting rule stored in a rule storage unit;

FIG. 5 is a diagram of an example of generation obtained by work order operation;

FIG. 6 is a diagram of an example of generation obtained by syntax expression conversion;

FIG. 7 is a diagram of an example of generation obtained by specific expression conversion;

FIG. 8 is a diagram of an example of a display where a highlighting unit has highlighted an information extracted result with color;

FIG. 9 is a diagram of an example of a display where the highlighting unit has highlighted a change point of supervised data with color;

FIG. 10 is a flowchart of a processing procedure of a supervised data generation processing conducted by the information extracting apparatus according to the embodiment;

FIG. 11 is a diagram of a computer system executing an information extracting program according to the embodiment; and

FIG. 12 is a functional block diagram of a constitution of a main unit of the computer system shown in FIG. 11.

### DETAILED DESCRIPTION

Exemplary embodiments of a method and an apparatus for extracting information, and a computer product according to the present invention are explained below in detail with reference to the accompanying drawings. In the following explanation, when a sentence or a word to be processed is English or Japanese, the Japanese will be represented in this text as it is.

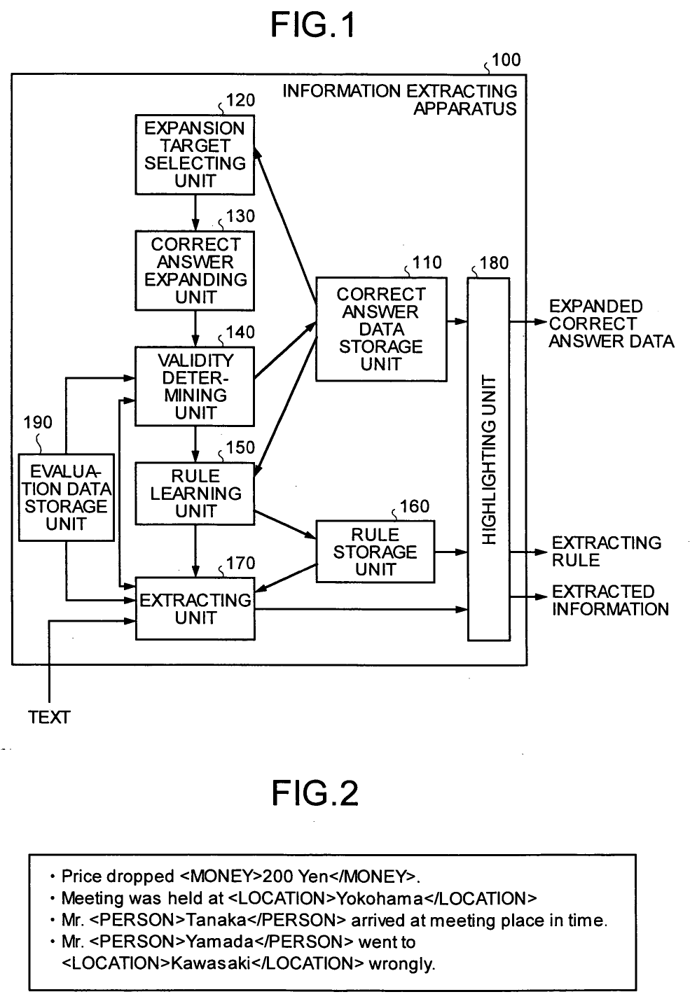

FIG. 1 is a block diagram of a constitution of an information extracting apparatus according to an embodiment of the present invention. The information extracting apparatus 100 has a supervised-data storage unit 110, an generation target selecting unit 120, a supervised data generation unit 130, a validity determining unit 140, a rule learning unit 150, a rule storage unit 160, an extracting unit 170, a highlighting unit 180 and an evaluation data storage unit 190.

The supervised-data storage unit 110 is a memory that stores supervised date to be used for machine learning. FIG. 2 is a diagram of an example of supervised data stored in the supervised-data storage unit 110. FIG. 2 represents supervised data used to induce information extracting rule for “MONEY” expression, “LOCATION” expression and “PERSON” expression from a text is prepared.

For example, a sentence ‘Price dropped <MONEY>200 Yen</MONEY>.’ is supervised data which is used to induce information extracting rule for “MONEY” expression from a text. Here, the ‘<MONEY>200 yen </MONEY>’ indicates that “200 yen” is “MONEY”. expression By using such supervised data, an information extracting rule for “MONEY” expression from a text can be prepared.

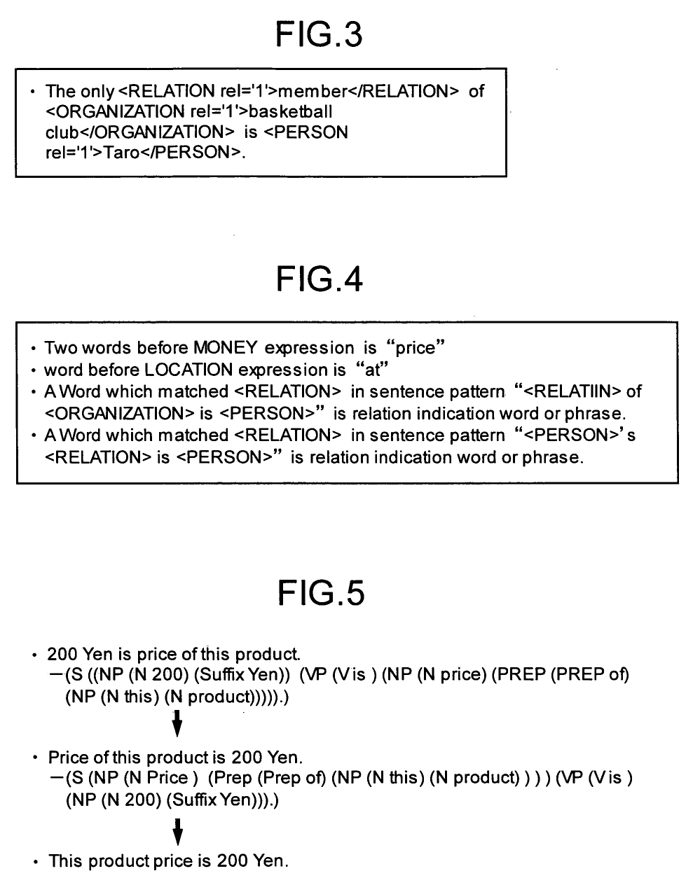

FIG. 3 is a diagram of another example of supervised data stored in the supervised-data storage unit 110. FIG. 3 represents supervised data used when an information extracting rule that allows extraction of information on “Relation indication word or phrase “between “PERSON” and “ORGANIZATION” from a text is prepared.

The supervised data indicates that “member” is “Relation indication word or phrase” of “PERSON Taro” and “ORANIZATION basket club”. By using such supervised data, an information extracting rule that extracts information of ‘Relation indication word or phrase’ between “PERSON” and “ORGANIZATION” from a text can be prepared.

The generation target selecting unit 120 is a processing unit that selects a supervised data piece to be generated from the supervised-data storage unit 110, and it can select a supervised data piece randomly or can select all supervised data pieces.

The supervised generating unit 130 is a processing unit that generates supervised data selected by the generation target selecting unit 120 to prepare generated data which is new supervised data. The supervised data generating unit 130 generates supervised data to prepare generated data, so that burden for preparing supervised data can be reduced. The details of supervised data generating processing performed by the supervised data generating unit 130 will be explained later.

The validity determining unit 140 is a processing unit that determines whether generated data prepared by the supervised data generating unit 130 is correct, and when determination is affirmative, adds the generated data to the supervised-data storage unit 110.

Specifically, the validity determining unit 140 adds the generated data to the supervised data to make learning and evaluates the learned result using test data. When the evaluation result is higher than an evaluation result obtained before addition of the generated data, the validity determining unit 140 determines that the generated data is proper.

The determination about whether the generated data is proper can be made based upon the number of retrieved results obtained by retrieving a large volume of documents such as Web pages or in-house documents using the generated data. That is, a large number of retrieved results means that the generated data is frequently used, from which determination can be made that the generated data is correct.

The validity determining unit 140 determines whether the generated data is proper. Therefore, by utilizing only the generated data determined to be proper as supervised data, incorrect data is prevented from being used for learning, so that learning precision can be improved.

The rule learning unit 150 is a processing unit that makes learning using the supervised data stored in the supervised-data storage unit 110 to prepare an information extracting rule. In learning made by the rule learning unit 150, more excellent results can be obtained according to increase in the number of variations of supervised data. Therefore, by generating the supervised data to increase the number of variations, more excellent information extracting rule can be obtained.

The rule storage unit 160 is a storage unit that stores an information extracting rule prepared by the rule learning unit 150. FIG. 4 is a diagram of an example of an information extracting rule stored in the rule storage unit 160. In FIG. 4, an information extracting rule such as ‘Two words before “MONEY” expression is price’ is an information extracting rule obtained from the supervised data “Price dropped <MONEY>200 Yen</MONEY>.”

That is, when morphological analysis is applied to the sentence “Price dropped <MONEY>200 Yen</MONEY>.” and “Price/Noun dropped/Verb 200/Num Yen/Suffix” is obtained. Therefore, since “price” comes two words before “<MONEY>200 Yen</MONEY>, a rule ‘Two words before MONEY expression is price’ is induced.

An information extracting rule ‘A word which matched <RELATION> in sentence pattern “<RELATIIN> of <ORGANIZATION> is <PERSON>” is relation indication word or phrase.’ is an information extracting rule induced by machine learning technique from supervised data ‘The only <RELATION rel=‘1’>member</RELATION> of <ORGANIZATION rel=‘1’>basketball club</ORGANIZATION> is <PERSON rel=‘1’>Taro</PERSON>.’ shown in FIG. 3.

The extracting unit 170 is a processing unit that extracts specific information or relationship from a text by using the information extracting rule stored in the rule storage unit 160. Here, the specific information includes ‘MONEY’,‘PERSON’ ‘LOCATION’ and the like, such as shown in FIG. 2, and the specific relationship includes ‘A word which matched <RELATION> in sentence pattern “<RELATIIN> of <ORGANIZATION> is <PERSON>” is relation indication word or phrase.’ and the like, to which supervised data shown in FIG. 3 are given.

The highlighting unit 180 is a processing unit that highlights and displays a generated portion of generated supervised data or a specific information portion in an information extraction result. As the highlighting approach, there are decorations performed by coloring, change in font and size, underline application, shading and the like.

The evaluation data storage unit 190 is a storage unit that stores test data used when correctness of generated data is evaluated and termination conditions for a supervised data generating processing. Here, the termination conditions for the supervised data generating processing include a target precision of information extraction, the number of repetitions of a supervised data generating processing and the like.

The supervised generating unit 130 performs generation of supervised data by operation such as word order operation, syntax expression conversion, and specific expression conversion.

FIG. 5 is a diagram of an example of generation conducted by a word order operation. When syntax analysis is applied to supervised data “200 Yen is price of this product.” (regarding an English parser, for example, see http://nlp.cs.nyu.edu/app/), such an analysis result can be obtained structure like “((NP (N Price) (PREP (PREP of) (NP (N this) (N product))))”.

Accordingly, changing the word order by using the structure information, “Price of this product is 200 Yen.” can be obtained. Furthermore, to change word order by using some grammatical rule, “This product price is 200 Yen.” can be obtained too.

An information extracting rule, “Two words before MONEY expression is product” and “Two words before MONEY expression is price” is obtained from the automatically generated supervised data, “Price of this product is 200 Yen.” and “This product price is 200 Yen.”. Naturally, information extracting rule, “Two words after MONEY expression is price” can be obtained from the original supervised data “200 Yen is price of this product.”. Accordingly, by generating supervised data according to such a work order operation, a new information extracting rule can be obtained, so that precision of information extraction can be improved.

Similarly, by changing the word order of supervised data, “Mr. Taro has a brother and a sister.” generated data “Mr. Taro has a sister and a brother.” can be obtained. And by deleting one of coordination “Mr. Taro has a sister.” and “Mr. Taro has a brother.” can be obtained.

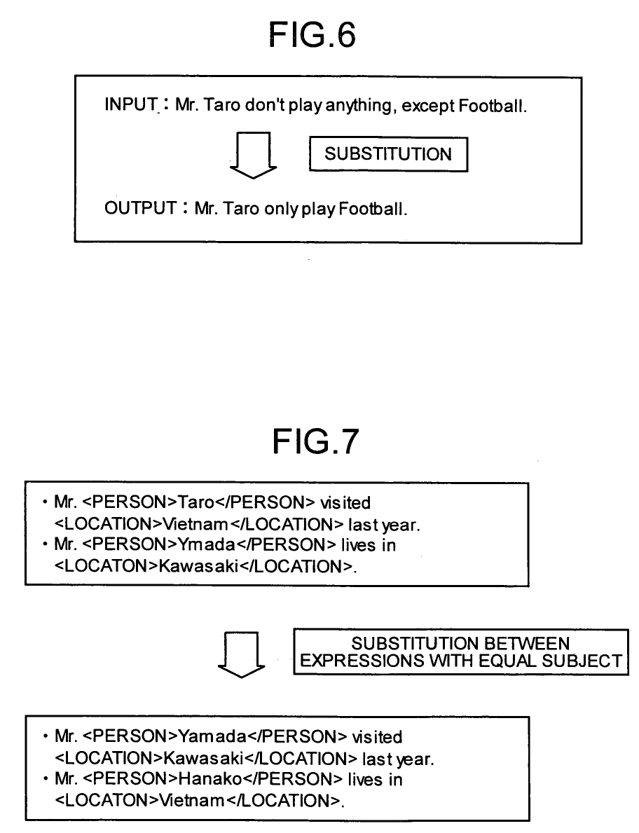

FIG. 6 is a diagram of an example where a synonymous sentence with a different syntax is produced using paraphrasing technique (regarding the expression changing technique, for example, a Japanese paraphrasing engine: http://cl.aist-nara-ac.jp/lab/kura/doc). As shown in FIG. 6, by applying the paraphrasing technology to supervised data “Mr. Taro don't play anything, except Football.” generated data “Mr. Taro only play Football” can be obtained.

As another example, “No <RELATION rel=‘1’>member</RELATION> is in <ORGANIZATION rel=‘1’>basketball club</ORGANIZATION>, except <PRESON rel=‘1’>Taro</PERSON> can be obtained from “The only <RELATION rel=‘1’>member</RELATION> of <ORGANIZATION rel=‘1’>basketball club</ORGANIZATION> is <PERSON rel=‘1’>Taro</PERSON>.” as a generated data.

Conversion of active sentence to a passive sentence, like “Police officer called Taro.” to “Taro was called by Police officer.” or converting a passive sentence to an active sentence, supervised data can be generated.

By converting a negative expression having a limiting meaning to an affirmative expression to convert “He dose not have money, except 1000 yen.” to “He only has 1000 yen” or converting an affirmative expression to an negative expression having a limiting meaning, supervised data can be generated.

Conversion of phrases which is used as same meaning of function word can also generate new sentences. For example, changing phrase of “In spite of” to “despite” convert “In spite of my fault, he forgave me into “Despite my fault, he forgave me.”.

Conversion of noun phrases can be performed to convert “4^{th} of July” to “July 4^{th}”. Conversion between synonymous words can be performed to convert a sentence “He is nothing but lazy.” to another sentence “He is no more than lazy.”

This invention is not restricted a specific language. For example, in Japanese, by converting an active sentence to a passive sentence, like ┌ [symbol] ┘, this sentence meaning is “Police stopped Taro”, ┌ [symbol] ┘, this sentence meaning is “Taro was stopped by police” or converting a passive sentence to an active sentence, can also generate new sentence. FIG. 7 is a diagram of an example of generation obtained by a specific expression conversion. As shown in FIG. 7, by performing substitution of equal subjects between supervised data pieces, for example regarding “PERSON” or “LOCATION”, new supervised data can be generated. In this example, by substituting “Taro” with “Hanako”, both being person names, or substituting “Vietnam” with “Kawasaki”, both being place's names, new supervised data can be generated. By performing substitution of specific expressions to supervised data using a synonym dictionary, an idiom dictionary or the like, generates new answer data . For example, a sentence ‘He kicked the bucket.’ can be substituted with ‘He died.’ using an idiom dictionary.

By converting alphabetical numerals to Arabic numerals to generate same meaning, but different expression sentence and its reverse procedure to convert Arabic numerals to alphabetical numerals can also generate supervised. For example, ‘His salary is 1000 Yen.’ is obtained from ‘His salary is one thousand Yen.’ to convert alphabetical numerals to Arabic numerals.

Conversion of DATE or TIME expression to another notation can also extend supervised. For example, conversion of “Meeting starts at 1 pm on March eighteenth” to “Meeting starts at 13:00 o'clock on 3/18.”, is performed in this manner.

By conversion of humble word or honorific word to normal expressions, like “I would like to ask director to do it.” to “I want to ask director to do it.” or performing normal expressions to humble word or honorific word, supervised data can be generated.

In Japanese, supervised data can be generated by performing conversion from a Chinese letter numerical expression to Arabic numerals to covert a sentence like [symbol] [symbol] this sentence meaning is “His salary is two thousands dollar.” to [symbol] 2 0 0 0 [symbol] or performing conversion from Arabic numerals to a Chinese letter numerical expression. Supervised data can be generated by using a thesaurus to convert “Where did you get that hat?” to “Where did you come by that hat?” Further, supervised data can be generated by performing recovery of abbreviated notation to convert “Please send email A.S.A.P” to “Please send email as soon as possible” or performing conversion to the abbreviated notation. Supervised data can also be generated by converting expression of DATE or TIME to another notation in Japanese too. One example is conversion of [symbol] [symbol] which meaning is “Meeting will start at eleven p.m.” [symbol] 11:00

[symbol]

Besides, supervised data can be generated by performing conversion between different languages such as English to Japanese or Japanese to English translation, for example, conversion (translation) between” <PERSON> Taro </PERSON> has a red pen.”and ┌<PERSON> [symbol] </PERSON> [symbol] [symbol] utilizing a machine translation technique.

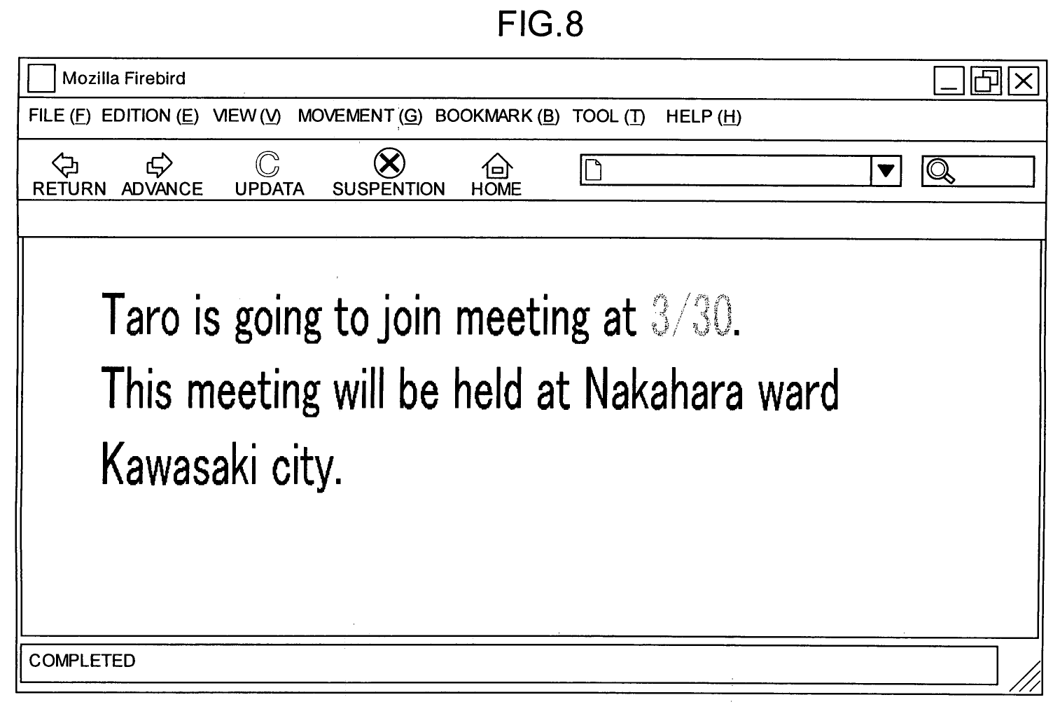

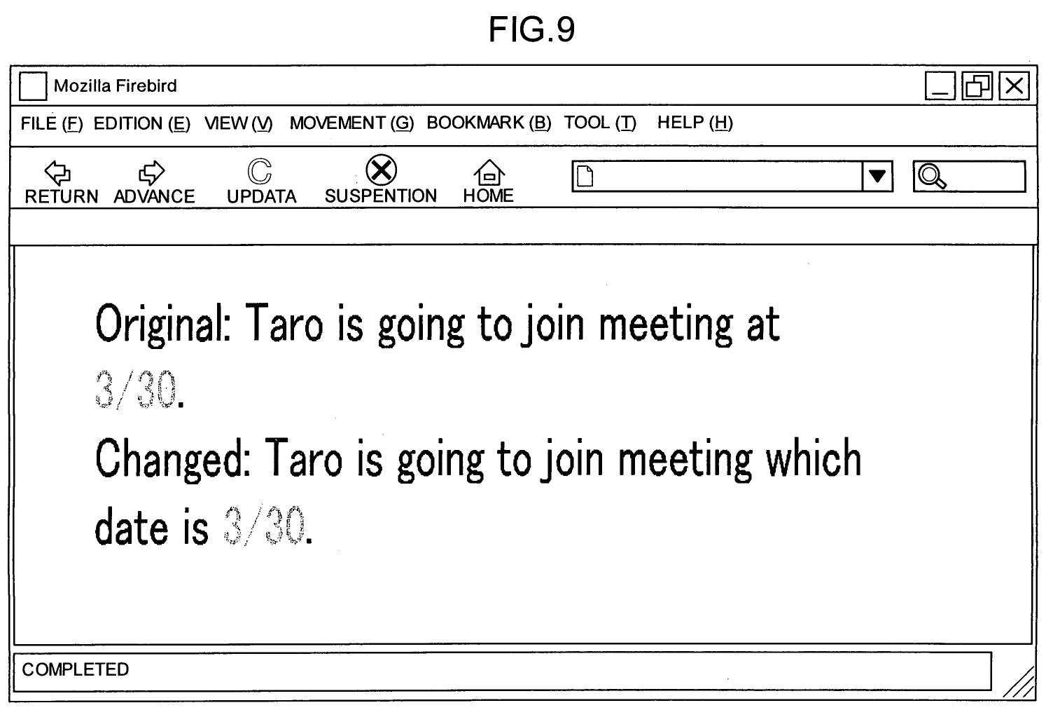

FIG. 8 is a diagram of a display example where the highlighting unit 180 has highlighted an information extraction result with color. FIG. 9 is a diagram of a display example where the highlighting unit 180 has highlighted a changing point of supervised data with color.

As shown in FIG. 8, since information pieces or words “3/30”, “Taro” and “Nakahara ward Kawasaki city” included in the extracted information “Taro is going to join meeting at 3/30. This meeting will be held at Nakahara ward Kawasaki city.” correspond to information pieces [DATE], [PERSON] and [LOCATION] designated to be extracted, respectively, they are displayed with color. In FIG. 8, the information pieces are shown with different hatching patterns, but they are colored in an actual display.

As shown in FIG. 9, the supervised data before changed “Taro is going to join meeting on 3/30.” and the generated data after the change is “Taro is going to join meeting which date is 3/30”, where how to modify is changed, so that these words are displayed with color. In FIG. 8 and FIG. 9, although displayed with different hatching patterns, these words are colored in an actual display.

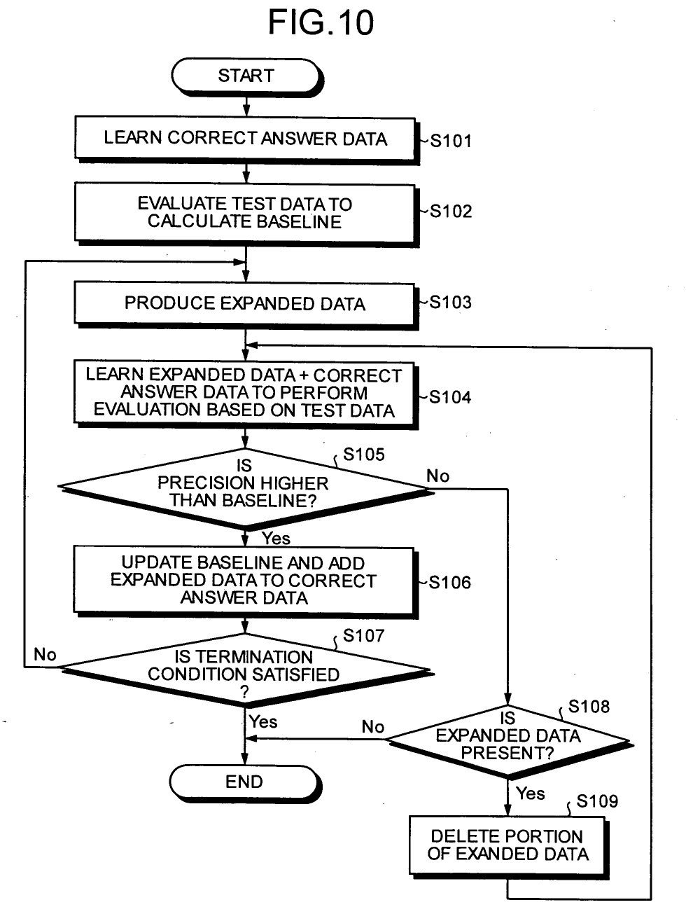

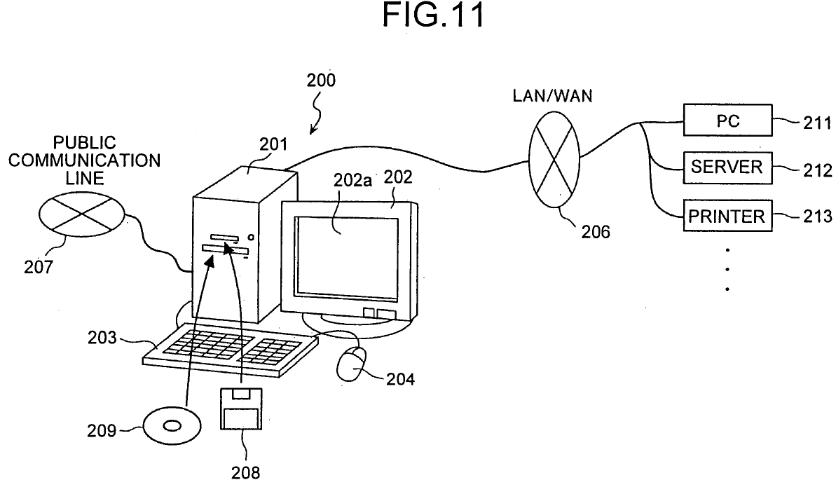

FIG. 10 is a flowchart of a processing procedure of supervised data generating processing conducted by the information extracting apparatus 100 according to this embodiment. Before starting the supervised data generating process, the supervised-data storage unit 110 stores supervised data before generated there in, and the evaluation data storage unit 190 stores test data and termination conditions for supervised data generating process therein in advance.

As shown in FIG. 10, in the information extracting apparatus 100, the validity determining unit 140 causes the rule learning unit 150 to learn supervised data stored in the supervised-data storage unit 110 (step S101) and causes the extracting unit 170 to perform information extraction using test data to evaluate the result and prepare a baseline for evaluation (step S102).

The generation target selecting unit 120 selects supervised data to be generated from the supervised-data storage unit 110 and the supervised generation unit 130 generates the supervised data to produce generated data (step S103). Here, the supervised generating unit 130 determines how to generate supervised data based upon a priority of a generating approach, the number of generation data pieces and the like.

The validity determining unit 140 causes the rule learning unit 150 to learn generated data and supervised data and cause the extracting unit 170 to perform information extraction using test data to evaluate the result thus obtained (step S104).

The validity determining unit 140 makes comparison about whether the evaluation result is higher than the baseline (step S105), and, when the evaluation result is higher than the baseline, updates the baseline with the evaluation result to add the generated data to the supervised data (step S106).

The control determines whether a termination condition is satisfied (step S107), and, when the termination condition is not satisfied, returns back to step S103 where repeating generation of the supervised data, while terminates the processing when the termination condition is satisfied.

On the other hand, when the evaluation result is not higher than the baseline, the validity determining unit 140 determines whether generated data is present (step S108) and, when the generated data is present, deletes one portion of the generated data (step S109), so that the control returns back to step S104. Here, the generated data to be deleted may be selected at random or may be selected based upon an overlapping degree of generated data pieces or the like.

Thus, the supervised generating unit 130 generates the supervised data, the validity determining unit 140 makes determination about correctness of the generated data using baseline, and when the determination result shows improvement in baseline, addition of the generated data to the supervised data improves an information extracting precision of the information extracting apparatus 100. Next, experimental results obtained by using the information extracting apparatus 100 according to this embodiment will be explained. In this experiment, data of Japanese information extraction contest, so-called “IREX” was utilized (http://www.cs1.sony.co.jp/person/sekine/IREX/). Data of a preliminary test (dryrun) was used as the supervised data, and data of an integrated subject (general) of this test was used as the evaluation data. Generation of the supervised data was performed according to a process that performs a word order operation by using the result of syntax analysis. Learning algorithms used was Boosting and SVM.

In the boosting algorithm, DecisionStump (a decision tree with a depth of 1) as a weak learner one was used. As a result, extraction F-measure was increased from 60.7% to 64.1% was obtained. In the SVM , experiment was performed by using polynomial kernel with the degree of 2. As a result, extraction F-measure was increased from 70.3% to 70.6%. In the information extracting apparatus 100 according to the embodiment, thus, the extraction precision for information can be improved without depending on a learning algorithm to be used.

As described above, in this embodiment, the generation target selecting unit 120 selects supervised data to be generated from the supervised-data storage unit 110, the supervised generation unit 130 generates the supervised data to produce generated data, the validity determining unit 140 causes the rule learning unit 150 to learn the generated data and the supervised data and causes the extracting unit 170 to perform information extraction using test data, and the validity determining unit 140 evaluates the result obtained and utilizes the generated data as supervised data when addition of the generated data indicates improvement as compared with the supervised data before the addition in the evaluated result. Therefore, preparation burden for supervised data can be reduced and precision of information extraction can be improved.

According to the present embodiment, the information extracting apparatus that generates supervised data and performs information extraction based upon the generated supervised data has been explained, but this invention is not limited to the embodiment. Similarly, the present invention can be applied to a case that preparation of an information extracting apparatus is supported by generating supervised data to perform operations up to preparation of an information extracting rule based upon the generated supervised data.

According to the present embodiment, the information extracting apparatus that learns supervised data to prepare an information extracting rule and performs information extraction based upon the prepared information extracting rule has been explained, but the present invention is not limited to this apparatus. The present invention can similarly be applied to another language processing technique applied apparatus utilizing machine learning.

According to the present, the information extracting apparatus has been explained, but an information extracting program having a similar function can be obtained by realizing a constitution possessed by the information extracting apparatus as a software. Now, a computer system for executing the information extracting program will be explained.

FIG. 11 is a schematic diagram of a computer system that executes an information extracting program according to this embodiment. As shown in FIG. 11, a computer system 200 has a main unit or main frame 201, a display 202 that displays information on a display screen 202a according to an instruction from the main unit 201, a keyboard 203 that is used for inputting various information pieces into the computer system 200, a mouse 204 that can indicate any position on the display screen 202a of the display 202, a LAN 206 or an LAN interface connecting to a wide area network (WAN) and a modem connected to a public communication line 207. Here, the LAN 206 connects the computer system 200 to another computer system (PC) 211, a server 212, a printer 213 and the like.

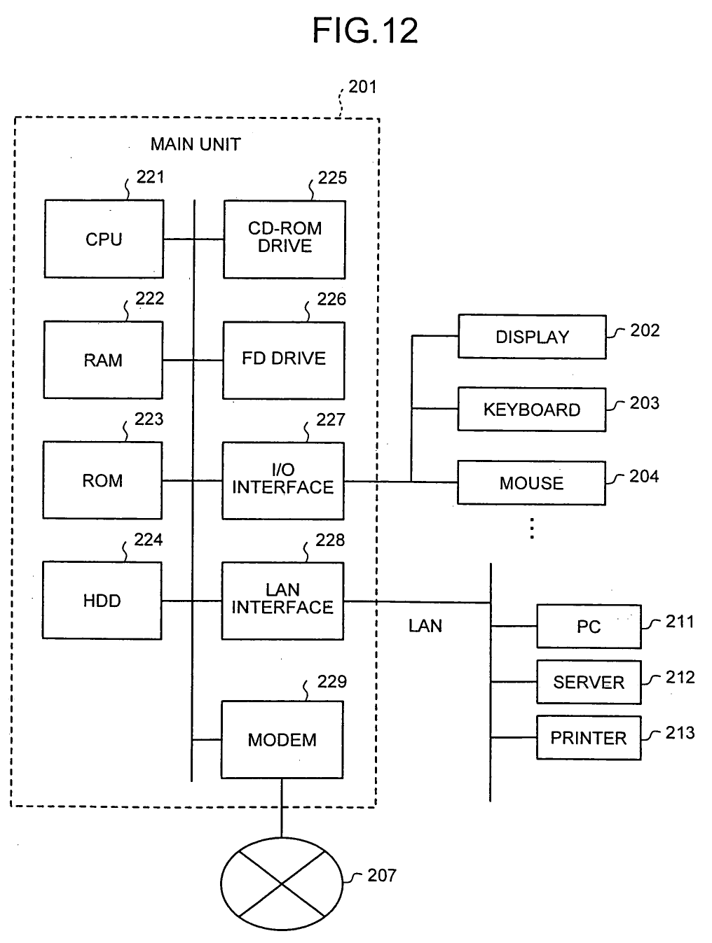

FIG. 12 is a functional block diagram of a constitution of the main unit 201 shown in FIG. 11. As shown in FIG. 11, the main unit 201 has a CPU 221, a RAM 222, a ROM 223, a hard disk drive (HDD) 224, a CD-ROM drive 225, an FD drive 226, an I/O interface 227, a LAN interface 228, and a modem 229.

An information extracting program executed in the computer system 200 is stored in a portable type recording medium such as a floppy disk (FD) 208, a CD-ROM 209, a DVD disk, a magneto-optical disk, an IC card, and it is read out from these media to be installed in the computer system 200.

Alternatively, the information extracting program is stored in a database of the server 212, a database of the another computer system (PC) 211 connected via the LAN interface 228, or the like, and it is read out from these databases to be installed in the computer system 200.

The information extracting program installed is stored in the HDD 224 and it is executed by the CPU 221 utilizing the RAM 222, the ROM 223 or the like.

According to the present invention, since learning is made, while the supervised data is automatically increased, burden for preparing supervised data can be reduced and precision for information extraction can also be improved.

According to the present invention, since learning is made using only proper supervised data of generated supervised data, precision of information extraction can securely be improved.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A computer program for extracting information from a text, based on an information extracting rule obtained by machine learning using supervised data, making a computer execute:
generating the supervised data to produce generated data; and
learning the information extracting rule using the generated data.

2. The computer program according to claim 1, further making the computer execute evaluating correctness of the generated data, wherein
the learning includes learning the information extracting rule using the generated data evaluated to be correct at the evaluating.

3. The computer program according to claim 1, further making the computer execute highlighting a difference between the generated data and the supervised data used for the generating when displaying the supervised data.

4. The computer program according to claim 1, wherein
the supervised data is a sentence, and
the generating includes changing a word order in the sentence.

5. The computer program according to claim 1, wherein
the supervised data is a sentence, and
the generating includes deleting a modifier in the sentence.

6. The computer program according to claim 1, wherein
the supervised data is a sentence, and
the generating includes changing expression of the sentence to produce another sentence having same meaning.

7. The computer program according to claim 6, wherein the changing expressing includes performing mutual conversion between a passive sentence and an active sentence.

8. The computer program according to claim 1, wherein
the supervised data is a sentence, and
the generating includes converting a specific expression in the sentence into another expression to produce a sentence having same meaning.

9. The computer program according to claim 8, wherein the converting includes converting a specific clause into a synonym using a synonym dictionary.

10. The computer program according to claim 8, wherein the converting includes converting a specific clause to a synonym using an idiom dictionary.

11. The computer program according to claim 8, wherein the converting includes converting a specific clause to a synonym using a respective word and a modest word.

12. The computer program according to claim 2, wherein
the learning includes adding the generated data, and
evaluating includes
evaluating a result of the learning using test data; and
evaluating the correctness of the generated data based on whether the result is improved by comparing the result before and after adding the generated data.

13. The computer program according to claim 2, wherein the evaluating includes
retrieving Web page using the generated data; and
evaluating the correctness based on number of hits in a result of the retrieving.

14. The computer program according to claim 1, wherein the information extracting rule is to extract a name of a person from the text.

15. The computer program according to claim 1, wherein the information extracting rule is to extract a predetermined relation from the text.

16. A computer-readable recording medium that stores a computer program for extracting information from a text, based on an information extracting rule obtained by machine learning using supervised data, the computer program making a computer execute:
generating the supervised data to produce generated data; and
learning the information extracting rule using the generated data.

17. An apparatus for extracting information from a text, based on an information extracting rule obtained by machine learning using supervised data, comprising:
a generating unit that generates the supervised data to produce generated data; and
a learning unit that learns the information extracting rule using the generated data.

18. A method of extracting information from a text, based on an information extracting rule obtained by machine learning using supervised data, comprising:
generating the supervised data to produce generated data; and
learning the information extracting rule using the generated data.

19. A method of creating an information extracting rule that is used to extract information from a text, by machine learning using supervised data, comprising:
generating the supervised data to produce generated data; and
creating the information extracting rule using the generated data.

20. The method according to claim 19, further comprising evaluating correctness of the generated data, wherein
the creating includes creating the information extracting rule using the generated data evaluated to be correct at the evaluating.
